(19) United States
(12) Patent Application Publication
(10) Pub. No.: US 2026/0273860 A1
(43) Pub. Date: Sep. 17, 2026

(54) METHOD FOR PREPARING A PROCESS IN ADDITIVE MANUFACTURING, AND COMPUTER PROGRAM PRODUCT

(71) Applicant: Siemens Energy Global GmbH & Co. KG, Munich, Bayern (DE)

(72) Inventors: Timo Heitmann, Berlin (DE); Julius Schurb, Berlin (DE)

(73) Assignee: Siemens Energy Global GmbH & Co. KG, Munich, Bayern (DE)

(21) Appl. No.: 19/473,453

(22) PCT Filed: Mar. 8, 2024
(86) PCT No.: PCT/EP2024/056158

§ 371 Date: Oct. 7, 2025

(30) Foreign Application Priority Data
Apr. 12, 2023 (DE) 10 2023 203 287.2

(51) Int. Cl. B29C 64/386; B29C 64/153; B33Y 10/00; B33Y 50/00

(52) U.S. Cl. CPC B29C 64/386; B29C 64/153; B33Y 50/00; B33Y 10/00

(57) ABSTRACT

A method for preparing a process in the additive manufacturing of a component. The method has the steps of importing a component geometry into a CAD environment, inspecting the component geometry for regions which are to be provided with a different resolution quality during the manufacture process, and separating the component geometry into at least two component sub-geometries on the basis of the inspection, wherein in the manufacturing process, a first sub-geometry is constructed using a first layer thickness, and a second sub-geometry which differs from the first sub-geometry is constructed using a second layer thickness, the second layer thickness being smaller than the first layer thickness, in particular half as large as the first layer thickness.

### CROSS REFERENCE TO RELATED APPLICATIONS

This application is the US National Stage of International Application No. PCT/EP2024/056158 filed 8 Mar. 2024, and claims the benefit thereof, which is incorporated by reference herein in its entirety. The International Application claims the benefit of German Application No. DE 102023203287.2 filed 12 Apr. 2023.

### FIELD OF INVENTION

The present invention relates to a, in particular computer-implemented, method for preparing a process in additive manufacturing of a component. The method relates to instructions in preparation for the process which, for example, form a control instruction for additive manufacturing along with CAM (“computer-aided manufacturing”) data.

The component or its geometry is not subject to any concrete limitations but can preferably be provided to be employed in a hot gas path of a gas turbine. For example, the component relates to a constituent to be cooled with a thin-walled or filigree design. Alternatively, or in addition, the component can be a constituent to be employed in the automotive or aviation sectors.

### BACKGROUND OF INVENTION

Additive manufacturing (AM) methods, also referred to colloquially as 3D printing, have, for example, as powder-bed methods, selective laser melting (SLM) or laser sintering (SLS), or electron-beam melting (EBM). “AM” has proven to be particularly advantageous for complex or filigree components, for example, labyrinth-like structures, cooling structures, and/or lightweight structures. In particular, additive production is advantageous due to a particularly short chain of process steps since a manufacturing or production step of a component can be done largely based on a corresponding CAD file and the selection of corresponding production parameters.

Manufacturing a turbine blade design, heat exchangers, or others, for example, via the laser powder bed fusion (LPBF) methods described advantageously enables implementing new geometries or concepts which can reduce manufacturing costs or construction and throughput times, optimize the manufacturing process and, for example, improve thermomechanical configuration or durability of the constituents.

Constituents manufactured in a conventional manner, for example by casting, are clearly inferior to the additive production route, for example with respect to their freedom in terms of shaping and also in relation to the required throughput time and high costs related therewith, as well as the production complexity.

However, the powder-bed process gives rise to high thermal stresses inherent to the component structure. In particular, irradiation paths or vectors which are sized too short lead to severe overheating, which in turn leads to warpage of the structure. Severe warpage during the construction process easily leads to structural detachments, thermal deformations, or geometric deviations outside permissible tolerances. The selection, validation, and realization of custom process and irradiation parameters is usually of corresponding complexity. A particularly subtle and geometry-dependent definition of the process parameters in turn frequently leads to long process and light exposure times and construction times of multiple days to weeks.

An important limiting factor in powder-bed based additive manufacturing therefore frequently relates to low productivity since powder layers usually have to be applied in the sub-100 μm range and strongly irradiated and solidified locally. Productivity can therefore be significantly increased by increasing the layer thickness, for example. However, this is accompanied by a loss of resolution quality, in particular relating to the resolution of small or filigree component structures, or by poorer dimensional accuracy of the component. By default, a kind of optimum is often sought here, and the low productivity or the long construction processes are accepted to a large extent for a given specification of surface quality and dimensional tolerances.

### SUMMARY OF INVENTION

It is therefore an object of the present invention to specify means which can achieve a clear improvement in productivity of powder-bed based additive processes.

This object is attained by the subject matter of the independent claims. Advantageous embodiments are the subject of the dependent claims.

An aspect of the present invention relates to a, in particular computer-implemented, method for handling a process in additive component manufacturing.

The method has importing a component geometry or CAD file into a CAM environment, and/or what is known as a build processor, a CAM system, a process controller, and/or an additive manufacturing plant.

Presently, a CAM environment is to be understood broadly; that is, importing this file can also occur in advance, for example, outside an image processor or a standard “pre-processing” environment. Thus, in the course of the method according to the invention, for example, no irradiation paths have to be established yet. To leverage the advantages according to the invention, it is only advantageous to continue to provide or have, for the import of the CAD file, information for orienting the component design in the installation space of the corresponding plant, a structure or surface requirement (resolution or structural quality), and/or, for example, a construction material with corresponding standard parameters.

Additionally, the method has inspecting, in particular algorithmically, the imported component geometry for partial regions of the component which are to be provided with a different resolution or structural quality (imaging quality) during the manufacturing process. This resolution quality can be predetermined, for example, by a component specification with respect to the surface quality or similar.

Additionally, the method has separating—on the basis of the inspection—the component geometry, in particular the CAD data model for actual subsequent 3D printing or the manufacturing process, into at least two component sub-geometries. This separation can also be a split or subdivision of volume regions of the component, which can generally be processed with different process parameters in the subsequent additive manufacturing method. This subdivision advantageously enables selecting the parameters so that productivity of the physical manufacturing process can be significantly increased by the method in preparation for the process introduced.

In the manufacturing process (subsequently), a first sub-geometry or a first component region is constructed using a first layer thickness, and a second sub-geometry which differs from the first sub-geometry is constructed using a second layer thickness, said second layer thickness being smaller than the first layer thickness, in particular half as large as the first layer thickness. As is known, the layer thickness is a measure preset in the course of CAM process preparation, according to which a raw material powder must be distributed over and over again on the manufacturing surface in a grid-like manner to enable layer-by-layer irradiation and solidification of the component regions.

In one embodiment, an inner or first region of the component geometry (cf. first sub-geometry) is processed using the first layer thickness, and an outer region, second region, or edge region of the component geometry (cf. second sub-geometry) is processed using the second layer thickness.

In one embodiment, the first layer thickness for the inner region is roughly 80 μm, and the second layer thickness for the outer region is roughly 40 μm. Without limitation, other layer thicknesses can alternatively also be selected for both the inner and outer regions, for example, to adapt and optimize productivity of the process for each of the sub-geometries.

In one embodiment, inspecting the component geometry in regions with a different resolution quality has identifying different component portions or component sub-constituents, wherein each component portion suggests application of various (determined) process parameters in the manufacturing process for itself or demands them in accordance with the resolution quality. In particular, this embodiment takes into account the complicated shaping of the components in additive processes and enables increasing the design requirements and the efficiency of the process already in preparation for manufacturing and shortening the construction time.

In one embodiment, separating, subdividing, or splitting the component geometry on the basis of the inspection is done in at least two sub-geometries per component portion. In this way, in particular, the surface quality can also be maintained per component portion, and the efficiency of manufacturing can nevertheless be significantly improved overall.

In one embodiment, different component portions have those with and without overhangs. That is, during the inspection (and the subdivision) according to this embodiment, the component geometry is inspected and separated in a targeted manner in relation to regions overhanging the manufacturing surface. A person skilled in the art of powder-bed based additive manufacturing readily appreciates that overhanging regions require special diligence in terms of manufacturing technology and must be processed with particular “custom” parameters.

Due to the difficulty of dissipating the heat input required for solidification and also of supporting these overhanging regions mechanically sufficiently in the process, it is necessary in particular to maintain heat input which defines the molten pool expansion and also a layer thickness in very narrow working ranges. For overhang angles which, measured on the basis of a normal of the manufacturing surface (see below), exceed 45°, it is often not possible at all to image corresponding overhangs in terms of production technology.

In one embodiment, the component geometry has an overhanging component portion, wherein, upon separation into component sub-geometries, dependent on the overhang angle, this portion is associated with a variable geometry width in at least one outer region. Preferably, the variable geometry width defines the outer sub-geometry and hence the corresponding region of the component which is processed using the second, that is, smaller, layer thickness. Presently, the measurement of the geometry width cited appropriately refers to a top view of the manufacturing surface, that is, a cross-section of the component design.

In one embodiment, the overhanging component portion in the outer region, that is, preferably the outer sub-geometry of this portion, is associated with a relatively large geometry width in case of a flat (or severe) overhang and with a smaller geometry width in case of a steeper overhang. As described further below in the particular exemplary embodiments, this embodiment offers the clear advantage for process efficiency of also determining the requirement for a layer thickness or layer gauge to be set correspondingly by defining the geometry width.

A further aspect of the present invention relates to a computer program product which is obtained using the method described and is adapted, in particular, as a part of or having a CAM file for controlling an additive manufacturing process. In particular, the computer program product has commands which, upon executing the corresponding program by a computer or a process controller in an additive manufacturing plant, cause the latter to perform the method described.

A CAD file or a computer program product can be provided or present, for example, as a (volatile or non-volatile) storage or playback medium, such as, e.g., a memory card, a USB stick, a CD-ROM or DVD, or even in the form of a downloadable file from a server and/or in a network. The provision can also be, for example, in a wireless communication network by transmitting a corresponding file with the computer program product. A computer program product may contain program code, machine code, or numerical control instructions, such as G-code and/or other executable program instructions in general.

A further aspect of the present invention relates to an additive manufacturing method having the method described for preparing a process, wherein the computer program product including the component geometry separated thereby is relayed or exported, for example, as a CAM manufacturing instruction to a machine controller of an additive manufacturing plant, and the component is additively manufactured correspondingly.

A further aspect of the present invention relates to a controller for an additive manufacturing plant which is adapted to execute the computer program product as a manufacturing instruction or to control the additive manufacturing plant correspondingly for the manufacturing process of the component.

Embodiments, features, and/or advantages presently concerning the method for preparing a process or the computer program product may likewise relate to the additive manufacturing plant and the controller, and vice versa.

As used herein, the term “and/or” or “respectively,” when utilized in a series of two or more elements, means that each of the elements listed may be used by itself, or any combination of two or more of the elements listed may be used.

Further details of the invention are described hereinafter by means of the figures.

### BRIEF DESCRIPTION OF THE DRAWINGS

FIG. 1 shows a schematic side view of the design of a component to be manufactured additively.

FIG. 2 shows a schematic perspective view of the design of FIG. 1.

FIG. 3 shows a schematic top view of a component portion of the design of FIG. 1 along section A-A.

FIG. 4 shows a schematic top view of a further (overhanging) component portion of the design of FIG. 1 along section B-B.

FIG. 5 shows a schematic top view of the overhanging component portion of the design of FIG. 1 along section C-C.

FIG. 6 shows a schematic side view of the overhanging component portion with further details.

FIG. 7 implies, by means of a schematic sketch, exemplary parameters and geometric relationships relevant to the manufacturing process.

FIG. 8 implies, by means of a schematic flow diagram, among other things, method steps according to the invention.

### DETAILED DESCRIPTION OF INVENTION

In the exemplary embodiments and figures, identical or identically acting elements may each be provided with the same reference symbols. The elements depicted and their sizes relative to one another are not to be regarded as true to scale; rather, individual elements may be depicted in exaggerated thickness or large dimensions for better visualization and/or for better understanding.

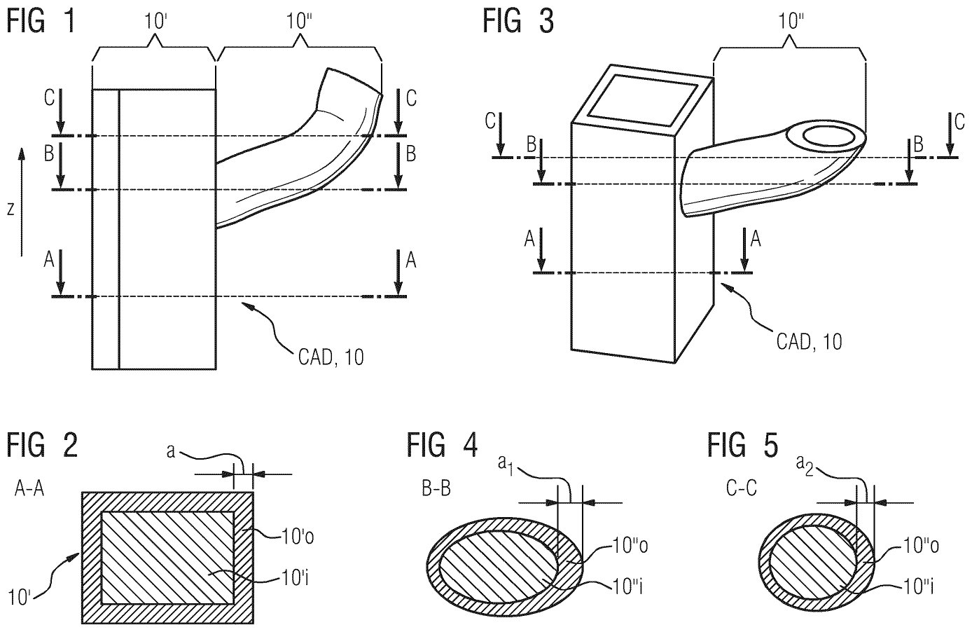

FIG. 1 shows an example CAD component geometry 10 of a component to be constructed additively. The attractive component is preferably to be manufactured by a powder-bed based (layer-by-layer) production process.

The component geometry 10 is subdivided into partial regions or partial portions 10′ and 10″. The left portion 10′ relates to a largely simple design with a square cross-section (cf. FIG. 2 further below), whereas the portion 10″ shown to the right of the depiction branches off from the stem of the first portion from a certain structural height (cf. reference symbol z).

Additionally, the portion 10″ relates to a region which is overhanging-in relation to a manufacturing surface (not explicitly labeled presently). The sections A, B and C drawn in broken lines in FIG. 1 are each depicted and described in a top view in FIGS. 2, 4 and 5 further below.

FIG. 2 shows a top view of a cross-section of the component design according to section A-A. For the sake of simplicity, a solid exemplary structure is shown which is subdivided into two exemplary sub-geometries or component regions by the method according to the invention described in more detail in FIG. 8. Inside the design, a first sub-geometry 10′i is shown in a rectangular shape. The component region correspondingly has a rectangular construction cross-section. Bordering this inner region, a second sub-geometry 10′o which differs from the first sub-geometry is depicted. A constant width (geometry width) of this edge region is implied by the reference symbol a.

The regions or sub-geometries cited are appropriately subdivided by the method according to the invention (in preparation for the process) after the entire component design 10 has been imported correspondingly, for example, into a CAM environment and/or a build processor and inspected for process or surface requirements, such as, for example, overhangs, thin structural walls.

According to the invention, the first (inner) sub-geometry is processed using a first layer thickness or set during the process. Analogously, the second sub-geometry is processed using a second layer thickness d2 which differs from the first layer thickness d1 (cf. FIG. 7 further below) and is preferably smaller, in particular half as large as the first layer thickness d1. In the present example, the subdivision according to the invention has the advantage that the first sub-geometry 10′i can be realized using a larger set layer thickness (cf. d1)—without running the risk of disadvantages in structural or resolution qualities—to make manufacturing faster and more efficient. The second sub-geometry 10′o (edge region) often requires better structural resolution or surface quality so that here, depending on the specification, a smaller layer thickness (cf. d2) must be selected.

In detail, the process may, for example, involve first applying (applying) a raw material powder layer according to the smaller layer thickness d2 to be selected and then exposing it to light according to parameters such as energy density or irradiation power, scanning speed, hatch distance, or the like. Additionally, in the physical manufacturing process, a further coating step may follow, which distributes the powder, for example, across the inner and outer portions. Subsequently, for example, only the outer region or the region which is more complicated with respect to resolution quality is exposed to light, and light exposure of the thicker powder layer is put on hold. The possibility of selecting different process or construction parameters in different partial regions of the component in some conventional manufacturing plants permits leveraging the invention presently described, which additionally expands the parameter space to include the layer thickness parameter, in a process-efficient manner.

FIG. 3 shows a perspective view of the component design 10 from which it may be appreciated that the portion 10′ has a square or rectangular (constant) cross-section. By contrast, the portion 10″ extends quasi-cylindrically (with a variable cross-section) away from the portion 10′.

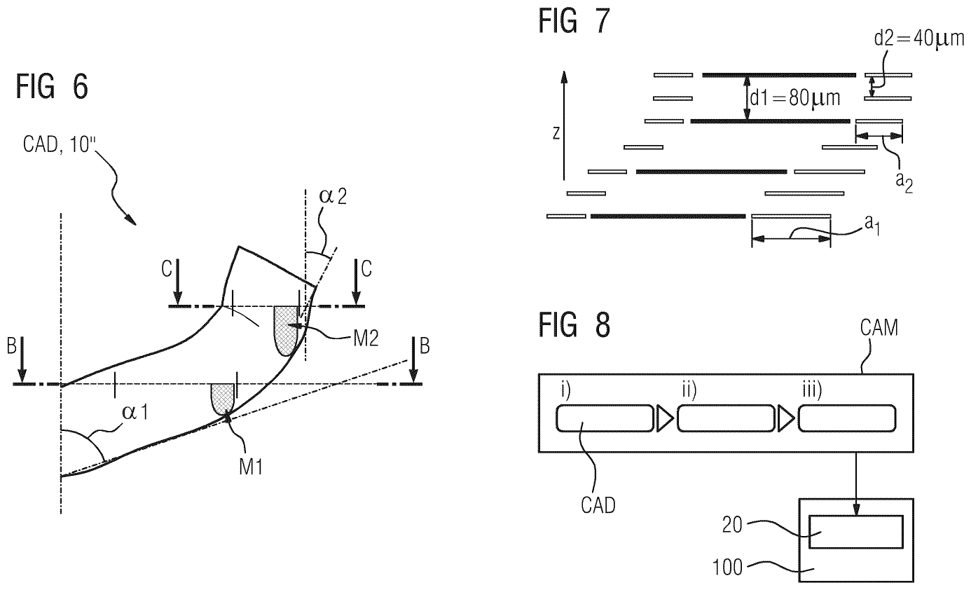

FIG. 4 depicts a top view of a cross-section of the component design according to section B-B which corresponds to a central part of the construction between sections A-A and C-C. In this part of the overhanging arm 10″, the overhang is flatter than described, for example, by means of FIG. 5. In other words, an overhang angle (cf. α1 in FIG. 6) is greater than shown, for example, in FIG. 5. Due to the flat course, the process preparation of component manufacturing along section B-B in the right cross-sectional region 10″o requires a wider edge region, consequently a larger width α1 of the sub-geometry. It is additionally illustrated that the width α1 varies over the circumference of the outer sub-geometry according to the design requirement of the component.

FIG. 5 shows a top view of a cross-section of the component design according to section C-C. In this part of construction, however, the overhanging region of the portion 10″ slopes upwards more steeply. The steeper course corresponds to a smaller overhang angle (cf. α2 in FIG. 6). Correspondingly, the geometry width α2 can be selected to be smaller than α1 (and approximately constant along the circumference) in the particular case.

More details of this relation are described by means of FIGS. 6 and 7. FIG. 6 schematically implies, in addition to the previously described figures, the described overhang angles and molten pool dimensions M1 and M2. The flatter portion along section B proceeds approximately according to angle α1 relative to the vertical or construction direction z; whereas the steeper course along section C extends upwards more steeply according to angle α2.

In the inner region of the sub-geometry 10′i, according to section B in FIG. 6, a drop-like molten pool M1 is implied which, in a horizontal dimension, is clearly smaller than the molten pool M2, which as a result is established in the region 10″i in the process to advantageously increase process efficiency clearly according to the invention. The increase in efficiency and construction time succeeds in particular due to the larger layer thickness to be selected (see further below), which, in conjunction with greater energy input, can also produce a larger (deeper in the z-direction) molten pool, and hence can melt and construct more volume per unit of time in the component inner region.

Referring to FIGS. 4 and 5, it is additionally clear from FIG. 7 that the flatter course (depicted at the bottom left) on the right side has a wider edge geometry (cf. width α1). This parameter is sized so as to be smaller at the top right of the figure due to the width α2—owing to the steeper course.

According to the invention, in the process preparation, the outer or first sub-geometry or the edge region is distinguished from the inner region (second sub-geometry) in that a smaller layer thickness of about d2=40 μm can be selected than in the inner region of, for example, about d1=80 μm. However, according to the invention, other values can also be set or selected without limiting general applicability.

Due to the flatter overhang region, which is actually more difficult to manufacture in terms of production technology (cf. larger overhang angle α1), it can be appreciated from FIG. 7 that the inner geometry with the larger layer thickness can thus be processed more efficiently, especially as the outer region is narrower. Described in other words, the construction of the flatter, larger overhanging region is more complex, and this region does not tolerate as large an efficiency optimization as, for example, the region which is steeper and easier to manufacture additively (cf. 10″i and 10″o).

FIG. 8 implies, by means of a schematic flow diagram, method steps according to the invention. Additionally, the reference symbol “CAM” is intended to imply a corresponding method product, in particular a computer program product, which, for example, can be relayed by data technology to or loaded into a controller 20 or an additive manufacturing plant 100 as an additive manufacturing instruction in the course of physical construction of the component to actually manufacture the component more efficiently due to the technical advantages imposed in preparation for the process.

The geometry of the component is usually established by a CAD (“computer-aided design”) file. After such a file has been read into a build processor of a manufacturing plant (cf. reference symbol 100), the process subsequently first requires establishing a suitable irradiation strategy, for example by standard process preparation via CAM, whereby, among other things, the component geometry is usually also divided into the individual layers.

In contrast, the method according to the invention is a method for preparing a process in the additive manufacturing of a component 10. The method explicitly has (i) importing a component geometry (CAD) into a CAM environment.

Additionally, the method explicitly has inspecting (ii) the component geometry CAD for regions (10′, 10″, 10′i, 10′o, 10″i, 10″o) which are to be provided with a different resolution quality during the manufacturing process.

Moreover, the method has (iii) separating the component geometry into at least two component sub-geometries 10′i, 10′o on the basis of the inspection, wherein in the manufacturing process, a first sub-geometry 10′i is constructed using a first layer thickness d1, and a second sub-geometry 10′o which differs from the first sub-geometry 10′i is constructed using a second layer thickness d2, said second layer thickness d2 being smaller than the first layer thickness d1, in particular half as large as the first layer thickness.

The computer program product cited, which is obtained using the method and is adapted, in particular, as a part of or having a CAM file for controlling an additive manufacturing process, appropriately has commands which, upon executing the program by a computer or a process controller 20 in an additive manufacturing plant 100, cause the latter to perform the method steps.

By contrast, the controller 20 for an additive manufacturing plant 100 is adapted to execute the computer program product as a manufacturing instruction or to control the additive manufacturing plant 100 correspondingly for the manufacturing process of the component 10.

Without limiting generality, any other arbitrary component geometry can be predefined, which can be imported, inspected, and separated correspondingly using the method described; this is largely independent of wall gauge lower limits, overhangs, or any other implications.

The component 10 described can be a component preferably to be employed in a hot gas path of a gas turbine. For example, the component relates to a constituent to be cooled with a thin-walled or filigree design. Alternatively, or in addition, the component can be a constituent to be employed in the automotive or aviation sectors.

1.-10. (canceled)

11. A method for preparing a process in the additive manufacturing of a component, comprising:
(i) importing a component geometry (CAD) into a CAM environment,
(ii) inspecting the component geometry (CAD) for regions which are to be provided with a different resolution quality during the manufacturing process, and
(iii) separating the component geometry into at least two component sub-geometries on the basis of the inspection, wherein in the manufacturing process, a first sub-geometry is constructed using a first layer thickness, and a second sub-geometry which differs from the first sub-geometry is constructed using a second layer thickness, said second layer thickness being smaller than the first layer thickness, in particular half as large as the first layer thickness, the different component portions having component portions with and without overhangs, wherein an inner region of the component geometry is processed using the first layer thickness, and an outer, or edge region of the component geometry is processed using the second layer thickness.

12. The method according to claim 11,
wherein the first layer thickness for the inner region is roughly 80 μm, and the second layer thickness for the outer region is roughly 40 μm.

13. The method according to claim 11,
wherein inspecting the component geometry in regions with a different resolution quality has identifying different component portions, and wherein each component portion suggests application of various process parameters in the manufacturing process for itself.

14. The method according to claim 13,
wherein separating the component geometry on the basis of the inspection is done in at least two component sub-geometries per component portion.

15. The method according to claim 11,
wherein the component geometry has an overhanging component portion, wherein, upon separation into component sub-geometries, dependent on an overhang angle, this portion is associated with a variable geometry width in at least one outer region, and wherein the variable geometry width defines the outer sub-geometry and hence the region of the component which is processed using the second layer thickness.

16. The method according to claim 15,
wherein the overhanging component portion in the outer region is associated with a relatively large geometry width in case of a flat overhang and with a smaller geometry width in case of a steeper overhang.

17. A computer program product stored on a non-transitory computer readable media, comprising:
commands which, upon executing the program by a computer or a process controller in an additive manufacturing plant, cause the latter to perform the method steps of claim 11.

18. An additive manufacturing method, comprising:
the method for preparing a process in the additive manufacturing of a component according to claim 11,
wherein a computer program product stored on a non-transitory computer readable media, including the component geometry separated thereby, is relayed as a manufacturing instruction to a machine controller of an additive manufacturing plant, and
wherein the component is additively manufactured correspondingly.

19. A controller for an additive manufacturing plant,
which is adapted to execute the computer program product of claim 17 as a manufacturing instruction or to control the additive manufacturing plant correspondingly for the manufacturing process of the component.
